(19) United States
(12) Patent Application Publication
(10) Pub. No.: US 2017/0122435 A1
(43) Pub. Date: May 4, 2017

(54) SEALING ARRANGEMENT

(71) Applicant: Trelleborg Sealing Solution US, Inc., US-Fort Wayne, IN (US)

(72) Inventors: Gabriel Molina, Anderstorp (SE); Jonas Lindgren, Bor (SE); Leif Soffronow, Värnamo (SE)

(73) Assignee: Trelleborg Sealing Solution US, Inc., US-Fort Wayne, IN (US)

(21) Appl. No.: 15/319,388

(22) PCT Filed: Jun. 10, 2015
(86) PCT No.: PCT/SE2015/050668

§ 371 Date: Dec. 16, 2016

(30) Foreign Application Priority Data
Jun. 18, 2014 (SE) 1450760-2

(51) Int. Cl. F16J 15/00; F16J 15/3256; B60C 23/00; F16C 33/78

(52) U.S. Cl. CPC F16J 15/002; F16C 33/7816; F16J 15/3256; B60C 23/003

(57) ABSTRACT

A cassette sealing arrangement, for a vehicle, providing air transfer between a shaft (7)and a hub (9) surrounding the shaft, with an air transfer chamber being divided into a first (19) and a second (21) ring-shaped compartment. The arrangement has a base ring (23), attached to the hub, and an inner sleeve (35), attached to the shaft. The first compartment (19) is defined between the first ring-shaped seal (41), a third ring-shaped seal (42), the base ring and the inner sleeve (35), and the second compartment (21) is defined between the second ring-shaped seal (47), a fourth ring-shaped seal (45), the base ring (23) and the inner sleeve (35). The ring shaped seals are attached to the base ring (23),and their central portions seal against the inner sleeve in such a way that the inner sleeve is allowed to rotate in relation to the first and third seals.

### TECHNICAL FIELD

The present disclosure relates to a sealing arrangement, for a vehicle, for providing air transfer between a shaft and a hub surrounding the shaft, one of which is connected to the body of the vehicle and the other to a wheel of the vehicle, the arrangement comprising a transfer chamber being ring-shaped and confined between the shaft, the hub, and at least a first and a second ring-shaped seal which are axially separated in the axial direction of the shaft.

### BACKGROUND

One example of such an arrangement is illustrated in FR-2874671-B1, where a chamber is formed between two ring-shaped seals which are attached to a rotating wheel, and which each create a sealing function against a ring shaped sleeve which has an L-shaped cross section. Two such ring-shaped sleeves are provided, and an air passage is provided in between the sleeves in order to feed air from a shaft, to which the sleeves are attached, and into the chamber. Such an arrangement may be used to provide a central tyre inflation, CTI, arrangement where air is led to a tyre of the wheel via the chamber. One problem associated with such systems is how to make the system more versatile and easy to use.

### SUMMARY

One object of the present invention is therefore to obtain a sealing arrangement that allows for an improved CTI system. This object is achieved by a sealing arrangement as claimed in claim 1. More specifically according to claim 1 there is provided an arrangement of the initially mentioned kind where the transfer chamber is divided into a first and a second ring-shaped compartment, the arrangement comprising a base ring, which is adapted to be attached to a hub, and an inner sleeve, which is adapted to be attached to a shaft. The first compartment is defined between the first ring-shaped seal, a third ring-shaped seal, the base ring and the inner sleeve, wherein the first and third seals are attached to the base ring, and the central portions of the first and third seals seal against the inner sleeve in such a way that the inner sleeve is allowed to rotate in relation to the first and third seals. The second compartment is defined between the second ring-shaped seal, a fourth ring-shaped seal, the base ring and the inner sleeve, wherein the second and fourth seals are attached to the base ring, and the central portions of the second and fourth seals seal against the inner sleeve in such a way that the inner sleeve is allowed to rotate in relation to the second and fourth seals.

Such a sealing arrangement allows one of the compartments to be used for transferring air to and from a tyre while the other compartment is sued for controlling e.g. a valve in the tyre. This provides for an improved arrangement where air can also be let out of a tyre as controlled through the sealing arrangment.

In cross section, the central ends of the first and third seals, where the first and third seals seal against the inner sleeve, may be bent in the direction towards the inner of the first compartment, and the central ends of the second and fourth seals, where the second and fourth seals seal against the inner sleeve, may be bent in the direction towards the inner of the second compartment. This allows a higher pressure to be used in the compartments.

A support washer may be sandwiched between the third and fourth ring-shaped seals, the washer supporting the seals laterally but leaving a gap free with respect to the inner sleeve. This mitigates the risk that the free ends, in cross section, of those seals roll in case the pressure becomes high.

The base ring may comprise an outer ring and an inner ring fitted inside the outer ring. The support washer and the third and fourth ring-shaped seals may be sandwiched between a first side of the inner ring and a first shoulder portion inside the outer ring. This provides a reliable way of attaching the ring shaped seals to the inner of the base ring.

The first ring-shaped seal may similarly be sandwiched between a first sheet metal frame and a second shoulder portion inside the outer ring, and the second ring-shaped seal may be sandwiched between a second sheet metal frame and a second side of the inner ring. Further, a rubber water seal, sealing against the inner sleeve, may be vulcanized on the first sheet metal frame, and a rubber oil seal, sealing against the inner sleeve, may be vulcanized on the second sheet metal frame.

The inner sleeve may comprise an evacuation opening between the positions where the second ring shaped seal and the oil seal interact with the inner sleeve. This allows air that could leak from the transfer chamber to escape and not enter e.g. a lubricated part where it could cause damage.

The rubber water seal and the rubber oil seal could be made of a material in a group including nitrile rubber, NBR, hydrogenated nitrile rubber, HNBR, and flouroelastomers, FKM.

One or more of the first, second, third and fourth ring shaped seals could be made of polytetraflourethylene, PTFE.

The base ring and the inner sleeve may comprise openings connecting the first and second compartments with the shaft and the hub.

The base ring may comprise peripheral seals surrounding and being vulcanized to the outer periphery of the base ring. This provides a tight grip between the base ring and an outer hub and seals the connections to channels in the hub.

### BRIEF DESCRIPTION OF THE DRAWINGS

FIG. 1 shows a front view of a wheel arrangement as seen from a vehicle body.

FIG. 2 shows a cross section of the arrangement in FIG. 1, where the location of a sealing structure is indicated.

FIG. 3 shows a part of the cross section of FIG. 2 enlarged.

FIG. 4 illustrates schematically the cassette seal of FIG. 3.

FIG. 5A shows an exploded perspective view of a cassette seal, and FIGS. 5B and 5C show enlarged portions of FIG. 5A.

### DETAILED DESCRIPTION

The present disclosure is related to solutions used in connection with vehicle central tyre inflation, CTI, systems. Such system allow to vary the pressure in a tyre by inflating or deflating a tyre without manually attaching a conduit to the tyre and supplying compressed air, or manually letting air out of the tyre via a valve. Instead, the vehicle itself adjusts the pressure in the tyre, automatically or being controlled by an operator.

Varying the tyre pressure can be useful under certain circumstances. For instance, in a tractor which enters a wet field, it may be useful to lower the tyre pressure to some extent. This flattens the tyres somewhat such that the tractor load is spread over a slightly greater surface, which may reduce driving damage on the field. On the other hand, when subsequently driving on a hard surface such as a road, it may be desired to increase the tyre pressure as this reduces rolling resistance and thus fuel consumption. This can be achieved in a convenient way with a CTI system, where the tyres can be fed with compressed air from the body of the vehicle, that can be provided with a compressor.

A CTI system requires an air passage between the body of the vehicle and the rotating wheel and this can be accomplished between two seals, confining a ring-shaped chamber space between e.g. an inner shaft and an outer hub.

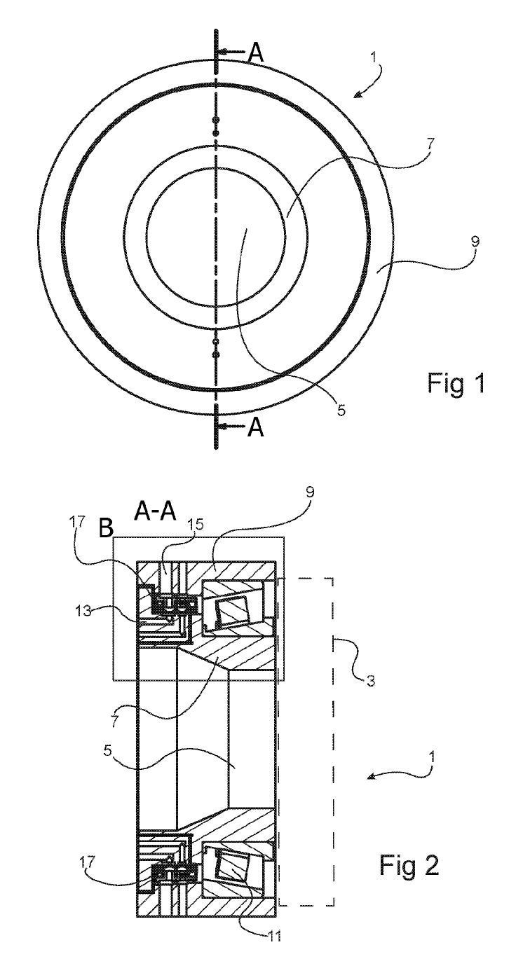

FIG. 1 shows a front view of a wheel arrangement 1, and FIG. 2 shows a side view with a cross section of the arrangement in FIG. 1, along the indicated line A-A. With reference to FIGS. 1 and 2, the wheel arrangement 1 shown can be used e.g. in a dump truck where a planetary gear, not shown, is located in a housing in an area 3, at the end of a fixed shaft 7. The gear is driven by a rotating drive shaft, not shown, which is connected to the sun gear of the planetary gear. The drive shaft passes through an opening 5 in the fixed shaft 7. The ring gear of the planetary gear is connected to the fixed shaft 7, and a rotating housing 9 to which a wheel and a tyre (not shown) are attached, is connected to the planet carrier of the planetary gear and is arranged to rotate around the axis of the fixed shaft being attached thereto by means of at least one bearing 11.

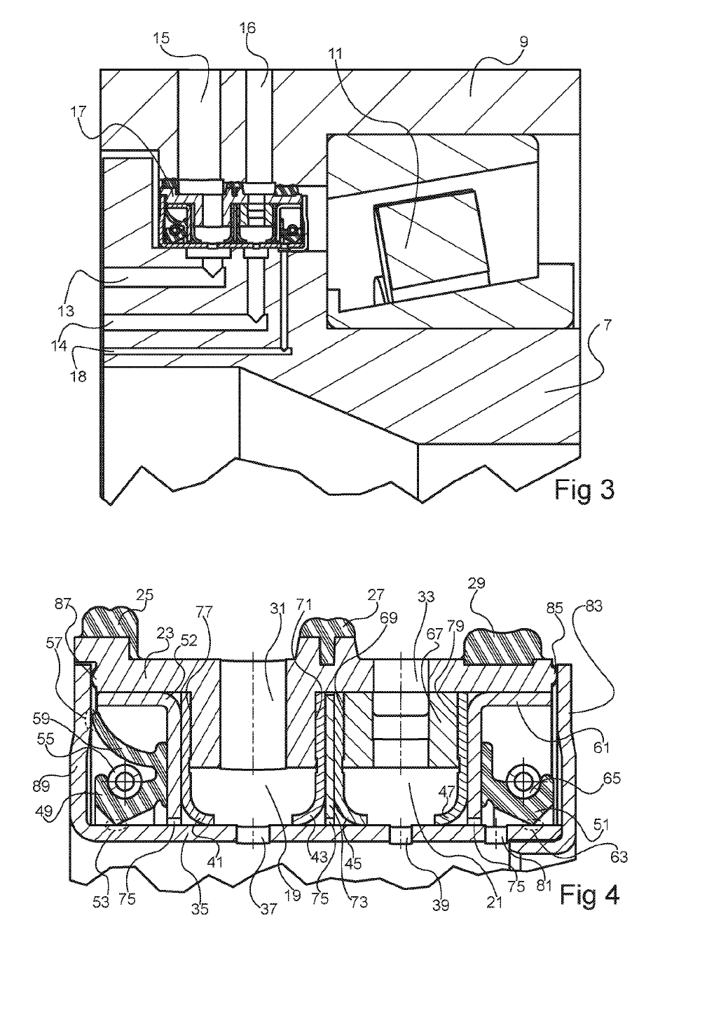

As can be seen in FIGS. 2 and 3, the arrangement provides a shaft channel 13 in the fixed shaft 7 and a wheel channel 15 in the rotating housing 9 for feeding pressurized air to the tyre (not shown) of the wheel attached to the rotating housing. The shaft channel 13 and the wheel channel 15 are interconnected by means of a ring shaped chamber formed by a sealing structure 17, which will now be described in more detail. In addition, in this disclosure, control channels 14, 16 are provided in the fixed shaft 7 and the rotating housing 9, respectively.

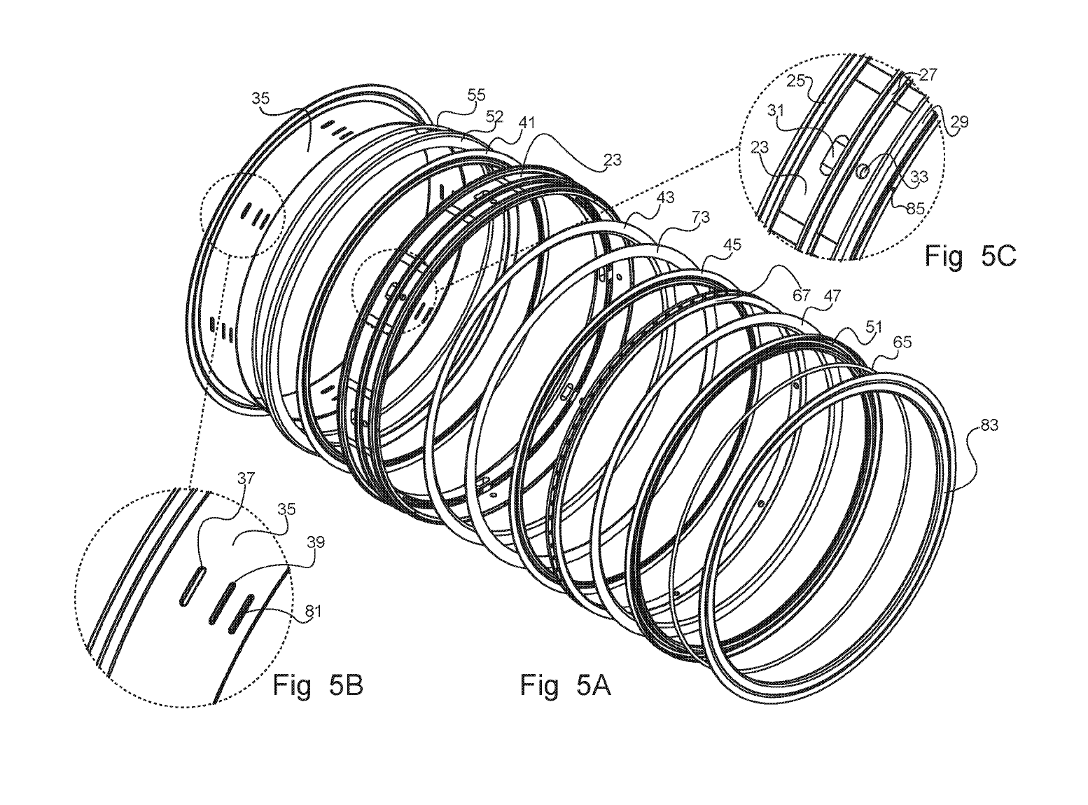

FIG. 4 illustrates the cassette or cartridge seal 17 of FIG. 3 and FIG. 5A show a corresponding exploded view of the cassette seal. By a cassette seal is meant that the sealing function is provided as a complete unit, including both a part connected to and being intended to be stationary with the rotating part and a part connected to and being intended to be stationary with the body of the vehicle. This means that friction between sealing parts, upon rotation of the rotating housing, will occur internally in the cassette seal rather than against the shaft or the hub themselves. This means that seal friction will not cause wear on the hub or shaft, and when the cassette is replaced during maintenance, all items subject to seal wear may be replaced, which improves the long term functionality. The concept of cassette or cartridge seals is well known per se.

In the sealing of the present disclosure, an air transfer chamber is divided into two ring shaped compartments 19, 21. Those compartments 19, 21 may themselves be designated as ring shaped chambers.

A first compartment 19 may be used in connection with transport channels (cf. 15, 13 in FIG. 3) in the wheel and in the vehicle body to transport air to and from the tyre, as mentioned above. A second compartment 21 may be used in connection with control channels (cf. 16, 14 in FIG. 3) in the wheel and in the vehicle body to control e.g. a valve in connection with the tyre. For instance, raising the pressure in the control channel through the second compartment 21 may result in valve in connection with the tyre being opened to let air out of the tyre, through the transport channel and the first compartment 19.

The cassette seal includes a base ring 23 which may be produced in a plastic material such as polyamide, PA, by injection moulding. The plastic material could be reinforced, e.g. with 30% glass fibre. The base ring 23 is intended to be fitted to the outer rotating hub/housing 9, and has peripheral seals, surrounding the outer periphery of the base ring and serving both to obtain a tight grip between the outer hub and the base ring, such that the base ring does not slip in relation to the hub, and to seal the connection between the channels in the hub and the inner of the compartments 19, 21. The peripheral seals 25, 27, 29 may comprise e.g. nitrile rubber, NBR, hydrogenated nitrile rubber, HNBR, or flouroelastomers FKM, and may be vulcanized to the base ring 23. The base ring further has openings 31 that connect the transport channel in the rotating housing 9 with the first ring shaped compartment 19, and openings 33 that connect the control channel in the rotating housing 9 with the second ring shaped compartment 21, as can also be seen in FIG. 5C. A number of such openings can be provided around the periphery. The peripheral seals 25, 27, 29, also visible in FIG. 5C, seal off the connection between the channels in the housing and the openings in the base ring. First 25 and second 27 peripheral seals seal off the connection to the first compartment 19, and the second 27 and third 29 peripheral seals provide the same function with regard to the second compartment 21. The base ring 23 will be stationary with regard to the hub 9, and therefore the peripheral seals 25, 27, 29 may be compressed between the base ring 23 and the hub, which provides a tight grip around the periphery of the base ring 23. Such peripheral seals may be useful also in a context where the air transfer chamber is not divided into first and second compartment. The disclosure thus considers a sealing arrangement for a vehicle for providing air transfer between a shaft and a hub surrounding the shaft, one of which is connected to the body of the vehicle and the other to a wheel of the vehicle, where the arrangement comprises a transfer chamber being ring-shaped and confined between the shaft, the hub, and at least a first and a second ring-shaped seal which are axially separated in the axial direction of the shaft, wherein a base ring, to which the first and second ring-shaped seals are attached, comprises peripheral seals surrounding and being vulcanized to the outer periphery of the base ring.

The inner part of the cassette seal comprises an inner sleeve 35 that may be made of carbon steel sheet metal. The inner sleeve 35 can be fitted to the fixed shaft 7 and comprises openings 37, 39, along the periphery, see also FIG. 5B, that connect the first and second compartments 19, 21 to the transport and control channels, respectively, of the fixed shaft 7.

Four air seals 41, 43, 45, 47 are used to define the first and second ring shaped compartments 19, 21 between the outer base ring 23 and the inner sleeve 35. The air seals are attached to the outer base ring 23, and this has proven to operate well in cold conditions when the seals contract slightly.

The air seals may be produced in polytetraflourethylene, PTFE, and are flat and ring shaped with a cross section which is bent at the inner end. Thus, the two air seals 41, 43 defining the first ring-shaped compartment 19 are bent inwards towards the central portion of the first compartment as shown in FIG. 4. In the same way, the two air seals 45, 47 defining the second ring-shaped compartment 21 are bent inwards towards the central portion of the second compartment.

Thanks to this configuration, if a channel is pressurized, the bent portions of the air seals will be forced towards the inner sleeve 35 and a tighter sealing function will result. When the channel is unused and consequently no overpressure is at hand, the bent inner portions of the air seals are pressed to a lesser extent against the inner sleeve which implies less rotational friction.

In addition to the air seals, the cassette comprises a water seal 49 and an oil seal 51 which are placed on either side of the ring shaped compartments 19, 21. The ring shaped water seal 49 may consist of e.g. nitrile rubber, NBR, hydrogenated nitrile rubber, HNBR, or flouroelastomers, FKM, and may be vulcanized on a sheet metal frame 52 that is fitted inside the base ring 23 and moves with the same. A first contact surface 53 of the water seal 49 seals against the inner sleeve 35, against which the water seal may be urged by means of a spring 55. The water seal 49 thereby protects the cassette seal from incoming water. Additionally, a second contact surface 57 may be achieved by means of a ring shaped lip 59 extending from the water seal 49 and which may mitigate e.g. dust reaching the first contact surface 53.

Possibly, as illustrated with the exception of the ring shaped lip 59, the oil seal 51 may be provided much as a mirror image of the water seal 49, being vulcanized on a sheet metal frame 61 and being urged against a third contact surface 63 by means of a spring 65. The oil seal serves to contain oil or grease in a lubricated part such as a planetary gear.

As mentioned, polytetraflourethylene, PTFE is considered a suitable material for the air seals 41-47 as such seals provide a good sealing function with low friction without lubrication, which could be difficult to apply inside the cassette. One suitable way of attaching such seals is to sandwich them within a stack inside the cassette. For this purpose, the base ring may comprise an outer ring 23 and an inner ring 67, fitted inside the outer ring. As illustrated, the third 43 and fourth 45 ring-shaped seals may be sandwiched between a first side 69 of the inner ring 67 and a first shoulder portion 71 on the inside of the outer ring 23. A support washer 73, e.g. comprising sheet metal, may be placed between the third 43 and fourth 45 ring-shaped seals. As is shown in the cross section in FIG. 4, this washer projects further towards the centre of the cassette than does the base ring, in the illustrated case beyond the point where the third and fourth seals bend towards the interior of their respective chamber compartment. This serves to stabilise, laterally, i.e. in the axial direction of the shaft, the seals to mitigate the risk that they roll, i.e. get bent, in the opposite direction as caused by a very high pressure difference between the chamber compartments 19, 21. The support washer does leave a gap 75 to the inner sleeve, relative to which it rotates, in order to stay clear from the inner sleeve.

The third and fourth seals are thus kept firmly in place between the inner 67 and outer ring 23 of the base ring, and the first and second air seals 41, 47 may be attached in a similar way. The first ring-shaped seal 41 may be sandwiched between the sheet metal frame 52 of the water seal 49 and a second shoulder portion 77 inside the outer base ring 23. The second ring-shaped seal 47 may be sandwiched between the sheet metal frame 61 of the oil seal 51 and a second side 79 of the inner base ring 67. The sheet metal frames 52, 61 extend further towards the inner sleeve 35 of the cassette while leaving gaps 75 to the latter, and provide similar stabilising functions as the support washer 73.

The inner sleeve 35 may comprise an evacuation opening 81 between the positions where the fourth ring-shaped seal 47 and the oil seal 51 interact with the inner sleeve. This mitigates the risk that pressurized air which could leak from the second compartment 21 leaks into a sensitive lubricated arrangement such as a planetary gear. Such air is instead evacuated through the opening 81 and optionally through a channel 18 (cf. FIG. 3) in the fixed shaft 7. Needless to say, this arrangement provides a solution also in cassette seals where a chamber is not divided into separate compartments. The disclosure thus considers a sealing arrangement, for a vehicle, for providing air transfer between a shaft and a hub surrounding the shaft, one of which is connected to the body of the vehicle and the other to a wheel of the vehicle, where the arrangement comprises a transfer chamber being ring-shaped and confined between an inner sleeve attached to the shaft, the hub, and at least a first and a second ring-shaped seal which are axially separated in the axial direction of the shaft, an oil seal being placed adjacent to the second seal, wherein the inner sleeve comprises an evacuation opening between the positions where the second ring shaped sleeve and the oil seal interact with the inner sleeve.

Outside the oil seal a radial sleeve 83 is attached which connects to the inner sleeve 35, and facilitates mounting of the cassette seal by providing a substantially radially directed surface on which the cassette seal can be pushed into place. An axially directed portion connects to the inner sleeve 35. On the other side of the cassette, the inner sleeve 35 itself has a radial portion 89, which provides the aforementioned second contact surface 57. The base ring 23 may comprises axially directed spherical beads 85, 87 that rest against the radially directed portion 89 of the inner sleeve 35, and the radial sleeve 83, respectively, to make sure that the parts in the cassette are correctly aligned upon mounting.

The present disclosure is not restricted to the above-described embodiment, and may be varied and altered in different ways within the scope of the appended claims.

1. A sealing arrangement, for a vehicle, for providing air transfer between a shaft and a hub surrounding the shaft, one of which is connected to the body of the vehicle and the other to a wheel of the vehicle, the arrangement comprising a transfer chamber being ring-shaped and confined between the shaft, the hub, and at least a first and a second ring-shaped seal which are axially separated in the axial direction of the shaft, wherein:
the transfer chamber is divided into a first and a second ring-shaped compartment,
the arrangement comprises a base ring, which is adapted to be attached to a hub, and an inner sleeve, which is adapted to be attached to a shaft,
the first compartment being defined between the first ring-shaped seal, a third ring-shaped seal, the base ring and the inner sleeve, the first and third seals being attached to the base ring, and the central portions of the first and third seals sealing against the inner sleeve in such a way that the inner sleeve is allowed to rotate in relation to the first and third seals, and
the second compartment being defined between the second ring-shaped seal, a fourth ring-shaped seal, the base ring and the inner sleeve, the second and fourth seals being attached to the base ring, and the central portions of the second and fourth seals sealing against the inner sleeve in such a way that the inner sleeve is allowed to rotate in relation to the second and fourth seals.

2. The sealing arrangement according to claim 1, wherein, in cross section, the central ends of the first and third seals, where the first and third seals seal against the inner sleeve, are bent in the direction towards the inner of the first compartment, and the central ends of the second and fourth seals, where the second and fourth seals seal against the inner sleeve, are bent in the direction towards the inner of the second compartment.

3. The sealing arrangement according to claim 2, wherein a support washer is sandwiched between the third and fourth ring-shaped seals, the washer supporting the seals laterally, but leaving a gap free with respect to the inner sleeve.

4. The sealing arrangement according to claim 3, wherein the base ring comprises an outer ring and an inner ring fitted inside the outer ring, the support washer and the third and fourth ring-shaped seals being sandwiched between a first side of the inner ring and a first shoulder portion inside the outer ring.

5. The sealing arrangement according to claim 4, wherein the first ring-shaped seal is sandwiched between a first sheet metal frame and a second shoulder portion inside the outer ring, and the second ring-shaped seal is sandwiched between a second sheet metal frame and a second side of the inner ring

6. The sealing arrangement according to claim 5, wherein a rubber water seal, sealing against the inner sleeve, is vulcanized on the first sheet metal frame, and a rubber oil seal, sealing against the inner sleeve, is vulcanized on the second sheet metal frame.

7. The sealing arrangement according to claim 6, wherein the inner sleeve comprises an evacuation opening between the positions where the second ring shaped seal and the oil seal interact with the inner sleeve.

8. The sealing arrangement according to claim 6, therein the rubber water seal and the rubber oil seal are made from a material in a group including nitrile rubber, NBR, hydrogenated nitrile rubber, HNBR, and flouroelastomers, FKM.

9. The sealing arrangement according to claim 1, wherein one or more of the first, second, third and fourth ring shaped seals are made of polytetraflourethylene (PTFE).

10. The sealing arrangement according to claim 1, wherein the base ring and the inner sleeve comprise openings, connecting the first and second compartments with the shaft and the hub.

11. The sealing arrangement according to claim 1, wherein the base ring comprises peripheral seals surrounding and being vulcanized to the outer periphery of the base ring.

12. A sealing arrangement, for a vehicle, for providing air transfer between a shaft and a hub surrounding the shaft, one of which is intended to be connected to the body of the vehicle and the other to a wheel of the vehicle, the arrangement comprising a transfer chamber being ring-shaped and confined between an inner sleeve intended to be attached to the shaft, a base ring intended to be attached to the hub, and at least a first and a second ring-shaped seal which are attached to the base ring, axially separated in the axial direction of the shaft, wherein the base ring comprises peripheral seals surrounding and being vulcanized to the outer periphery of the base ring.

13. A sealing arrangement, for a vehicle, for providing air transfer between a shaft and a hub surrounding the shaft, one of which is connected to the body of the vehicle and the other to a wheel of the vehicle, the arrangement comprising a transfer chamber being ring-shaped and confined between an inner sleeve attached to the shaft, the hub, and at least a first and a second ring-shaped seal which are axially separated in the axial direction of the shaft, an oil seal being placed adjacent to the second seal, wherein the inner sleeve comprising an evacuation opening between the positions where the second ring shaped sleeve and the oil seal interact with the inner sleeve.
